(19) United States
(12) Patent Application Publication
(10) Pub. No.: US 2024/0239453 A1
(43) Pub. Date: Jul. 18, 2024

(54) WATERCRAFT MANEUVERING SYSTEM AND WATERCRAFT INCLUDING THE WATERCRAFT MANEUVERING SYSTEM

(71) Applicant: YAMAHA HATSUDOKI KABUSHIKI KAISHA, Iwata-shi (JP)

(72) Inventors: Yuhei SUZUKI, Shizuoka (JP); Ryo NAKANISHI, Shizuoka (JP)

(21) Appl. No.: 18/413,622

(22) Filed: Jan. 16, 2024

(30) Foreign Application Priority Data
Jan. 17, 2023 (JP) 2023-005381

(51) Int. Cl. B63B 79/40; B63B 79/10; B63H 20/12; H02P 7/29; H02P 29/024

(52) U.S. Cl. CPC B63B 79/40; B63B 79/10; B63H 20/12; H02P 7/29; H02P 29/027

(57) ABSTRACT

A watercraft maneuvering system includes a steering including a steering actuator including a DC motor and operable to change a steering angle to change a course of a watercraft, a steering angle sensor to detect the steering angle, and a steering controller configured or programmed to drive the steering actuator by feedback-controlling the DC motor based on a target steering angle and an output signal of the steering angle sensor. The steering controller is configured or programmed to perform a voltage control operation to control a voltage to be applied to the DC motor, and perform a voltage limiting control operation to limit the voltage to be applied to the DC motor based on a motor current flowing through the DC motor.

### CROSS REFERENCE TO RELATED APPLICATIONS

This application claims the benefit of priority to Japanese Patent Application No. 2023-005381 filed on Jan. 17, 2023. The entire contents of this application are hereby incorporated herein by reference.

### BACKGROUND OF THE INVENTION

### 1. Field of the Invention

The present invention relates to watercraft maneuvering systems, and watercraft including the watercraft maneuvering systems.

### 2. Description of the Related Art

JP 4019315 discloses a motor vehicle steering control system. The motor vehicle steering control system includes a motor, a vehicle wheel steering shaft to be rotationally driven by the motor, a pinion to be rotated together with the vehicle wheel steering shaft, a rack bar meshed with the pinion, and a steering shaft angle detection portion to detect the angular position of the vehicle wheel steering shaft. A target angular position is determined based on the angular position of a steering wheel, and the operation of the motor is controlled via a motor driver so that the angular position of the vehicle wheel steering shaft approaches the target angular position. The motor is a three-phase brushless motor, and the motor driver includes three pairs of semiconductor switching devices which are arranged as corresponding to three phases to form an H-type bridge. The semiconductor switching devices are controlled by Pulse Width Modulation (PWM) signals applied from a driving control portion constituted by a microcomputer. An electric current flowing through the motor is detected by an electric current sensor. When the detected electric current value exceeds a predetermined value, a lock mechanism is actuated to connect the vehicle wheel steering shaft to a steering wheel shaft connected to the steering wheel so that the motor is stopped to be thus protected.

### SUMMARY OF THE INVENTION

The inventors of example embodiments of the present invention described and claimed in the present application conducted an extensive study and research regarding a watercraft maneuvering system, and in doing so, discovered and first recognized new unique challenges and previously unrecognized possibilities for improvements as described in greater detail below.

In JP 4019315, there is no description of a steering control system applicable to a watercraft.

Example embodiments of the present invention provide watercraft maneuvering systems suitable for the steering of watercraft, and watercraft including the watercraft maneuvering systems.

In order to overcome the previously unrecognized and unsolved challenges described above, an example embodiment of the present invention provides a watercraft maneuvering system including a steering including a steering actuator including a DC motor (Direct Current motor) and operable to change a steering angle to change the course of a watercraft, a steering angle sensor to detect the steering angle, and a steering controller configured or programmed to drive the steering actuator by feedback-controlling the DC motor based on a target steering angle and an output signal of the steering angle sensor. The steering controller is configured or programmed to perform a voltage control operation to control a voltage to be applied to the DC motor, and to perform a voltage limiting control operation to limit the voltage to be applied to the DC motor based on a motor current flowing through the DC motor.

In the present example embodiment, the steering actuator includes the DC motor, and the steering is actuated by the power of the DC motor to change the steering angle so as to change the course of the watercraft. The use of the DC motor is advantageous in that the cost of the steering actuator can be reduced. On the other hand, the motor current of the DC motor varies depending on a load torque, making it impossible to directly control the motor current. In the present example embodiment, therefore, the voltage control operation is performed to feedback-control the DC motor so that the steering angle (actual steering angle) detected by the steering angle sensor approaches the target steering angle and, at the same time, the voltage to be applied to the DC motor is limited based on the motor current. This makes it possible to properly feedback-control the steering with the use of a less expensive DC motor while avoiding an overcurrent state. Thus, the watercraft maneuvering system is suitable for the steering of the watercraft.

In an example embodiment of the present invention, the steering controller is configured or programmed to perform the voltage limiting control operation when a voltage limiting condition including at least one of a motor current condition in which the motor current exceeds a predetermined electric current threshold, or an electric current increase rate condition in which an increase rate of the motor current exceeds a predetermined increase rate threshold is satisfied.

With this arrangement, at least one of the motor current condition or the electric current increase rate condition is included in the voltage limiting condition and, when the voltage limiting condition is satisfied, the voltage limiting control operation is performed. This makes it possible to properly feedback-control the steering with the use of the DC motor while avoiding an overcurrent state.

In an example embodiment of the present invention, the steering controller is configured or programmed to perform the voltage limiting control operation when the voltage limiting condition is continuously satisfied for a predetermined period or longer.

With this arrangement, the voltage is limited on the condition that the voltage limiting condition is continuously satisfied for the predetermined period or longer and, therefore, an unnecessary voltage limitation can be avoided. This makes it possible to achieve a stable control while avoiding an overcurrent state.

In an example embodiment of the present invention, the steering controller is configured or programmed to perform the voltage control operation by controlling a motor driving circuit connected to the DC motor through a PWM (Pulse Width Modulation) control, and to limit a duty ratio of the PWM control in the voltage limiting control operation.

With this arrangement, the voltage to be applied to the DC motor can be limited by limiting the duty ratio of the PWM control. The limitation of the duty ratio may be achieved by a limiting process in which the upper limit of the duty ratio is limited to a smaller value than in an ordinary process (in which the voltage limiting condition is not satisfied), or may be achieved by multiplying an ordinary duty ratio by a factor less than 1 (e.g., a predetermined factor).

In an example embodiment of the present invention, the watercraft maneuvering system further includes a steering operator to be operated by a user (an operator) to perform a steering operation, and an operation sensor to detect the steering operation of the steering operator. The steering controller is configured or programmed to compute the target steering angle based on the output signal of the operation sensor.

With this arrangement, the steering controller computes the target steering angle based on the output signal of the operation sensor to detect the operation of the steering operator and, therefore, can feedback-control the steering actuator by using the target steering angle. Therefore, an overcurrent can be avoided by controlling the voltage to be applied to the DC motor of the steering actuator based on the operation of the steering operator and limiting the application voltage based on the motor current.

In an example embodiment of the present invention, the watercraft maneuvering system further includes a main controller configured or programmed to generate the target steering angle and to apply the target steering angle to the steering controller in a watercraft maneuvering mode independent of the steering operation of the steering operator.

With this arrangement, the watercraft maneuvering mode independent of the steering operation of the steering operator can be provided. The watercraft maneuvering mode may be a joystick mode, an automatic watercraft maneuvering mode, or the like.

In an example embodiment of the present invention, the steering actuator includes a hydraulic actuator including a hydraulic cylinder and a pump to supply a hydraulic oil to the hydraulic cylinder, and the DC motor is operable to drive the pump.

With this arrangement, the steering can be actuated by the electric pump operated hydraulic actuator which includes the DC motor as a drive source. In this case, it is possible to control the voltage of the DC motor while properly avoiding an overcurrent by limiting the voltage based on the motor current.

In an example embodiment of the present invention, the steering is operable to steer an outboard motor attached to a hull of the watercraft.

Another example embodiment of the present invention provides a watercraft maneuvering system including a steering including a steering actuator including a DC motor (direct current motor) and operable to change a steering angle to change a course of a watercraft, and a steering controller configured or programmed to perform a voltage control operation to drive the DC motor, and to perform a voltage limiting control operation to limit a voltage to be applied to the DC motor when a predetermined overcurrent condition is satisfied.

In the present example embodiment, the steering actuator includes the DC motor, and actuates the steering by the power of the DC motor to change the course of the watercraft. The use of the DC motor is advantageous in that the cost of the steering actuator can be reduced. On the other hand, the motor current of the DC motor varies depending on a load torque, making it impossible to directly control the motor current. In the present example embodiment, therefore, the voltage control operation is performed to control the DC motor and, at the same time, the voltage to be applied to the DC motor is limited based on the motor current. This makes it possible to properly control the steering with the use of a less expensive DC motor while avoiding an overcurrent state. Thus, the watercraft maneuvering system is suitable to steer the watercraft.

Another further example embodiment of the present invention provides a watercraft including a hull, and a watercraft maneuvering system provided on the hull and including any of the aforementioned features.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view showing an exemplary construction of a watercraft mounted with a watercraft maneuvering system according to an example embodiment of the present invention.

FIG. 2 is a diagram showing a configuration of a watercraft maneuvering system by way of example.

FIG. 3 is a diagram showing the structure of a steering by way of example.

FIG. 4 is a block diagram showing a configuration of a steering controller by way of example.

FIG. 5 is a flowchart for describing an exemplary voltage limiting control operation to be performed by the steering controller.

### DETAILED DESCRIPTION OF THE EXAMPLE EMBODIMENTS

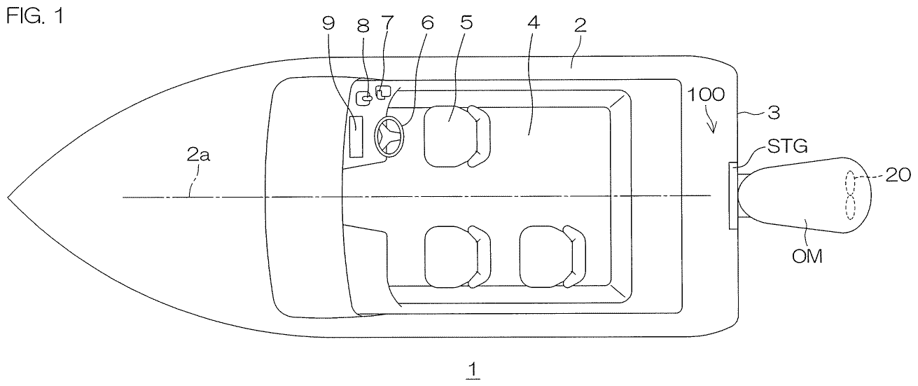

FIG. 1 is a plan view showing an exemplary construction of a watercraft 1 mounted with a watercraft maneuvering system 100 according to an example embodiment of the present invention. The watercraft 1 includes a hull 2, and an outboard motor OM as an exemplary propulsion device. The outboard motor OM is attached to the stern 3 of the hull 2. A steering STG is provided on the stern 3 to steer the outboard motor OM leftward and rightward. The steering STG is a mechanism that changes the direction of a propulsive force generated by the outboard motor OM leftward and rightward. The steering STG pivots (turns) the body of the outboard motor OM leftward and rightward with respect to the hull 2 such that a steering angle is changed to change the course of the watercraft 1. In the present example embodiment, the steering angle is defined as the angle of the propulsive force of the outboard motor OM with respect to the anteroposterior direction of the hull 2. That is, the steering angle is an angle defined between the direction of the propulsive force of the outboard motor OM and a center line 2a extending anteroposteriorly of the hull 2 as seen in a plan view.

A usable space 4 for passengers is provided inside the hull 2. A helm seat 5 is provided in the usable space 4. A steering wheel 6, a remote control lever 7, a joystick 8, a gauge 9 (display panel) and the like are provided in association with the helm seat 5. The steering wheel 6 is an example of a steering operator to be operated by a user (an operator) to change the course of the watercraft 1. The remote control lever 7 is an operator to be operated by the user to change the magnitude (output) and the direction (forward or reverse direction) of the propulsive force of the outboard motor OM, and corresponds to an acceleration operator. The joystick 8 is an operator to be operated instead of the steering wheel 6 and the remote control lever 7 by the user to maneuver the watercraft. The joystick 8 is another example of the steering operator. The gauge 9 is a display device on which information regarding watercraft maneuvering is displayed, and is an exemplary notification device.

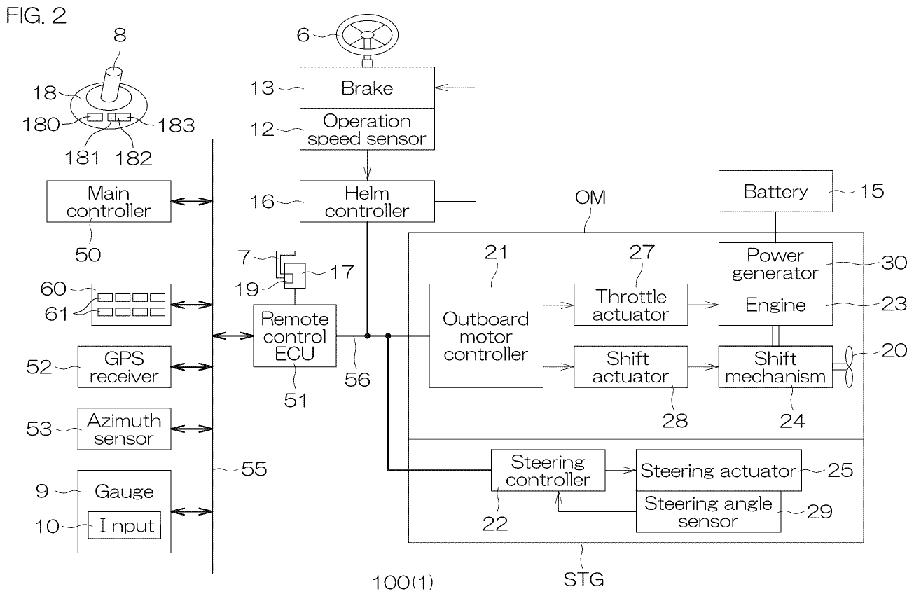

FIG. 2 is a diagram showing the configuration of the watercraft maneuvering system 100 provided in the watercraft 1 by way of example.

The outboard motor OM may be an engine outboard motor or an electric outboard motor. In FIG. 2, the outboard motor OM is illustrated as an engine outboard motor by way of example. The outboard motor OM includes an outboard motor controller (electronic control unit) 21, an engine 23, a shift mechanism 24, a propeller 20, a power generator 30 and the like. The power generator 30 is driven by the engine 23. The power generator 30 supplies electric power to the electric components of the outboard motor OM, and charges a battery 15 provided on the hull 2 (see FIG. 1).

Power generated by the engine 23 is transmitted to the propeller 20 via the shift mechanism 24. The shift mechanism 24 is configured to select a shift position from a forward shift position, a reverse shift position, and a neutral shift position. With the shift position set to the forward shift position, the propeller 20 is rotated in a forward rotation direction by the transmission of the rotation of the engine 23 such that the outboard motor OM is brought into a forward drive state to generate a forward propulsive force. With the shift position set to the reverse shift position, the propeller 20 is rotated in a reverse rotation direction by the transmission of the rotation of the engine 23 such that the outboard motor OM is brought into a reverse drive state to generate a reverse propulsive force. With the shift position set to the neutral shift position, the power transmission between the engine 23 and the propeller 20 is interrupted such that the outboard motor OM is brought into an idling state.

The outboard motor OM further includes a throttle actuator 27 and a shift actuator 28, which are controlled by the outboard motor controller 21. The throttle actuator 27 is an electric actuator (typically including an electric motor) that actuates the throttle valve (not shown) of the engine 23. The shift actuator 28 is an actuator (typically including an electric motor) that actuates the shift mechanism 24.

The steering STG includes a steering controller 22 and a steering actuator 25. The steering controller 22 is configured or programmed to drive the steering actuator 25. The steering actuator 25 is a drive source of the steering STG, and typically includes an electric motor. The steering actuator 25 may include a ball screw mechanism to be driven by the electric motor. Alternatively, the steering actuator 25 may be a hydraulic actuator including a hydraulic cylinder to which a hydraulic oil is supplied by a pump (electric pump) driven by the electric motor.

In the present example embodiment, the steering STG is configured as a separate unit from the outboard motor OM, and attached to the stern 3. However, the steering STG may be unified with the outboard motor OM, and may be incorporated in the outboard motor OM. Further, a portion (e.g., the steering controller 22) of the steering STG may be incorporated in the body of the outboard motor OM. A steering angle sensor 29 that detects the steering angle is incorporated in the steering STG. The steering angle sensor 29 may be a position sensor to detect the position of a movable portion of the steering actuator 25. Alternatively, the steering angle sensor 29 may be a position sensor to detect the position of a movable portion of a link mechanism (not shown) that transmits the drive force of the steering actuator 25 to the outboard motor OM. Thus, the steering angle sensor 29 outputs a signal indicating the steering angle of the outboard motor OM. The position sensor may be a noncontact magnetic sensor including, for example, a Hall device and a magnet.

The steering wheel 6 is configured to be rotatable about its rotation axis. The steering wheel 6 is a steering operator having a limitless rotation operation range with no operation range limits. An operation speed sensor 12 that detects the speed of the rotation operation (operation speed) of the steering wheel 6 is provided in association with the steering wheel 6. The operation speed sensor 12 is an exemplary operation amount sensor to detect the operation amount of the steering wheel 6. The operation speed sensor 12 detects an operation amount per unit time as the operation speed, and generates a signal indicating the operation speed. The operation speed sensor 12 is an example of the operation sensor to detect the operation of the steering wheel 6. The output signal of the operation speed sensor 12 is inputted to a helm controller 16. In association with the rotation shaft of the steering wheel 6, a brake 13 (typically, an electromagnetic brake) is provided as a rotation restricting device that restricts the rotation of the steering wheel 6. The brake 13 is controlled by the helm controller 16 to restrict the rotation of the rotation shaft of the steering wheel 6 to thus restrict the rotation of the steering wheel 6.

As described above, the steering wheel 6 has the limitless rotation operation range, and is limitlessly rotatable leftward and rightward. On the other hand, the steering range of the outboard motor OM has mechanical limitations, i.e., has a right steering limit and a left steering limit. Therefore, when the steering angle of the outboard motor OM corresponds to the right steering limit or the left steering limit, the helm controller 16 actuates the brake 13 to restrict the rotation of the steering wheel 6. Thus, the user who operates the steering wheel 6 can recognize, through tactile feedback from the steering wheel 6, that the steering angle of the outboard motor OM reaches either of the steering limits. The right steering limit and the left steering limit of the steering range of the outboard motor OM to be steered by the steering STG are often set inward of the mechanical steering limits of the outboard motor OM (closer to a neutral steering angle position).

The remote control lever 7 is pivotally provided to a remote control unit 17. The remote control unit 17 includes an operation position sensor 19 that detects the operation position of the remote control lever 7. The output signal of the operation position sensor 19 is inputted to a remote control ECU (Electronic Control Unit) 51.

The outboard motor controller 21 and the steering controller 22 are connected to an outboard motor control network 56. Further, the helm controller 16 and the remote control ECU 51 are connected to the outboard motor control network 56.

The helm controller 16 applies the operation speed detected by the operation speed sensor 12 to the steering controller 22 via the outboard motor control network 56. The steering controller 22 controls the steering actuator 25 according to the operation speed applied from the helm controller 16. The steering controller 22 may output the steering angle of the outboard motor OM detected by the steering angle sensor 29 or a target steering angle (to be described below) to the outboard motor control network 56. The steering controller 22 may apply a helm lock command to the helm controller 16 when the steering angle of the outboard motor OM reaches either of the steering limits. Upon reception of the helm lock command from the steering controller 22, the helm controller 16 actuates the brake 13 to restrict the rotation of the steering wheel 6.

The steering controller 22 may apply the helm lock command to the helm controller 16, for example, when the target steering angle (to be described below) has a value corresponding to either of the steering limits. Further, the steering controller 22 may apply the helm lock command to the helm controller 16, when the steering angle (actual steering angle) detected by the steering angle sensor 29 has the value corresponding to either of the steering limits. The helm lock command is exemplary steering angle information indicating that the steering angle of the outboard motor OM corresponds to either of the steering limits.

Instead of the steering controller 22 outputting the helm lock command, the helm controller 16 may actuate the brake 13 according to the target steering angle or the actual steering angle appearing on the outboard motor control network 56. That is, the helm controller 16 may be configured to actuate the brake 13 to restrict the rotation of the steering wheel 6 when the target steering angle or the actual steering angle has the value corresponding to either of the steering limits.

The remote control ECU 51 generates a propulsive force command according to the position of the remote control lever 7 detected by the operation position sensor 19, and applies the propulsive force command to the outboard motor controller 21 via the outboard motor control network 56. The propulsive force command includes a shift command and an output command. The outboard motor controller 21 controls the shift actuator 28 based on the shift command to control the shift position of the shift mechanism 24. The outboard motor controller 21 controls the throttle actuator 27 based on the output command to control the output (rotation speed) of the engine 23.

A main controller 50 is connected to the remote control ECU 51 via an onboard network 55 (e.g., CAN: Control Area Network). A joystick unit 18 is connected to the main controller 50. The joystick unit 18 includes the joystick 8, which can be inclined forward, backward, leftward, and rightward (i.e., in all 360-degree directions) and can be pivoted (twisted) about its axis. Though not shown, the joystick unit 18 includes an inclination sensor to detect the inclination operation direction and the inclination operation amount of the joystick 8, and a pivot sensor to detect the pivot operation direction and the pivot operation amount of the joystick 8. The inclination sensor includes an anteroposterior component sensor to detect the anteroposterior inclination component of the joystick 8, and a lateral component sensor to detect the lateral inclination component of the joystick 8. The detection values of the inclination sensor and the pivot sensor are inputted to the main controller 50.

In the present example, the joystick unit 18 further includes a plurality of operation buttons. The operation buttons include a joystick button 180, and holding mode setting buttons 181 to 183. The joystick button 180 is an operator to be operated by the user to select a control mode (watercraft maneuvering mode) using the joystick 8, i.e., a joystick mode. The holding mode setting buttons 181 to 183 are operation buttons to be operated by the user to select position/azimuth holding control modes (examples of the automatic watercraft maneuvering mode). More specifically, the holding mode setting button 181 is operated to select a fixed point holding mode (Stay Point™) in which the position and the bow azimuth (or the stern azimuth) of the watercraft are maintained. The holding mode setting button 182 is operated to select a position holding mode (Fish Point™) in which the position of the watercraft is maintained but the bow azimuth (or the stern azimuth) of the watercraft is not maintained. The holding mode setting button 183 is operated to select an azimuth holding mode (Drift Point™) in which the bow azimuth (or the stern azimuth) of the watercraft is maintained but the position of the watercraft is not maintained.

Further, a GPS (Global Positioning System) receiver 52, an azimuth sensor 53, an application switch panel 60 and the like are connected to the onboard network 55. The GPS receiver 52 is an exemplary position detecting device. The GPS receiver 52 detects the position of the watercraft 1 by receiving radio waves from an artificial satellite orbiting the earth, and outputs position data indicating the position of the watercraft 1 and speed data indicating the moving speed of the watercraft 1. The main controller 50 acquires the position data and the speed data, which are used to control and display the position and/or the azimuth of the watercraft 1. The GPS is a specific example of a GNSS (Global Navigation Satellite System). The azimuth sensor 53 detects the azimuth of the watercraft 1, and generates azimuth data which is used by the main controller 50.

The application switch panel 60 includes a plurality of function switches 61 operable to apply predefined function commands. For example, the function switches 61 may include switches for automatic watercraft maneuvering commands. More specifically, a command for a bow holding mode (Heading Hold) in which an automatic steering operation is performed to maintain the bow azimuth during forward sailing may be assigned to one of the function switches 61, and a command for a straight sailing holding mode (Course Hold) in which an automatic steering operation is performed to maintain the bow azimuth and a straight course during forward sailing may be assigned to another of the function switches 61. Further, a command for a checkpoint following mode (Track Point) in which an automatic steering operation is performed to follow a course (route) passing through specified checkpoints may be assigned to further another of the function switches 61, and a command for a pattern sailing mode (Pattern Steer) in which an automatic steering operation is performed to follow a predetermined sailing pattern (zig-zag pattern, spiral pattern or the like) may be assigned to still another of the function switches 61. These modes are examples of the automatic watercraft maneuvering mode.

Further, the gauge 9 is connected to the onboard network 55. The gauge 9 is a display device that displays various information for the watercraft maneuvering. The gauge 9 can communicate, for example, with the main controller 50, the remote control ECU 51 and the like. Thus, the gauge 9 can display the operation state of the outboard motor OM, the position and/or the azimuth of the watercraft 1 and other information. The gauge 9 may include an input device 10 such as a touch panel and buttons. The input device 10 may be operated by the user to set various settings and provide various commands such that operation signals are outputted to the onboard network 55. An additional network other than the onboard network 55 may be provided to transmit display control signals related to the gauge 9.

The main controller 50 includes a processor and a memory (both not shown), and is configured or programmed so that the processor executes a program stored in the memory to perform a plurality of functions. The main controller 50 includes a plurality of control modes. The control modes of the main controller 50 are classified into an ordinary watercraft maneuvering mode, the joystick mode, or the automatic watercraft maneuvering mode in terms of the operation system.

The ordinary watercraft maneuvering mode is a control mode in which a steering control operation is performed according to the operation of the steering wheel 6 and a propulsive force control operation is performed according to the operation of the remote control lever 7. In the present example embodiment, the ordinary watercraft maneuvering mode is a default control mode of the main controller 50. In the steering control operation, specifically, the steering controller 22 drives the steering actuator 25 according to an operation speed signal generated by the operation speed sensor 12 according to the operation of the steering wheel 6 or a steering angle command (specifically, a target steering angle command) generated by the remote control ECU 51. Thus, the outboard motor OM is steered leftward and rightward to change the direction of the propulsive force to be applied to the hull 2 leftward and rightward. In the propulsive force control operation, specifically, the outboard motor controller 21 drives the shift actuator 28 and the throttle actuator 27 according to the propulsive force command (the shift command and the output command) applied to the outboard motor controller 21 by the remote control ECU 51. Thus, the shift position of the outboard motor OM is set to the forward shift position, the reverse shift position, or the neutral shift position, and the engine output (specifically, the engine rotation speed) is changed.

The joystick mode is a control mode in which the steering control operation and the propulsive force control operation are performed according to the operation signal of the joystick 8. In the joystick mode, the steering control operation and the propulsive force control operation are performed according to the operation of the joystick 8. That is, the main controller 50 applies the steering angle command and the propulsive force command to the remote control ECU 51 according to the operation of the joystick 8. The remote control ECU 51 applies the steering angle command to the steering controller 22, and applies the propulsive force command to the outboard motor controller 21.

The automatic watercraft maneuvering mode is a control mode in which the steering control operation and/or the propulsive force control operation are automatically performed by the functions of the main controller 50 and the like without the operation of the steering wheel 6, the remote control lever 7, or the joystick 8. That is, an automatic watercraft maneuvering operation is performed. The automatic watercraft maneuvering operation includes an automatic watercraft maneuvering operation to be performed on a sailing basis during sailing, and an automatic watercraft maneuvering operation to be performed on a position/azimuth holding basis to maintain one or both of the position and the azimuth. Examples of the automatic watercraft maneuvering operation on the sailing basis include the automatic steering operations to be selected by operating the function switches 61. Examples of the automatic watercraft maneuvering operation on the position/azimuth holding basis include watercraft maneuvering operations to be performed in the fixed point holding mode, the position holding mode, and the azimuth holding mode which are respectively selected by operating the holding mode setting buttons 181, 182, and 183. In the automatic watercraft maneuvering mode, the main controller 50 generates the steering angle command and the propulsive force command by using the position information generated by the GPS receiver 52 and/or the azimuth information generated by the azimuth sensor 53. In the automatic watercraft maneuvering mode, the main controller 50 applies the steering angle command and the propulsive force command to the remote control ECU 51, and the remote control ECU 51 applies the steering angle command to the steering controller 22 and applies the propulsive force command to the outboard motor controller 21 as in the joystick mode.

In the joystick mode and the automatic watercraft maneuvering mode, the helm controller 16 does not need to supply the output of the operation speed sensor 12 to the outboard motor control network 56. Alternatively, the steering controller 22 may be configured or programmed so as not to respond to the operation speed signal outputted to the outboard motor control network 56 by the helm controller 16 when the steering angle command is applied from the remote control ECU 51.

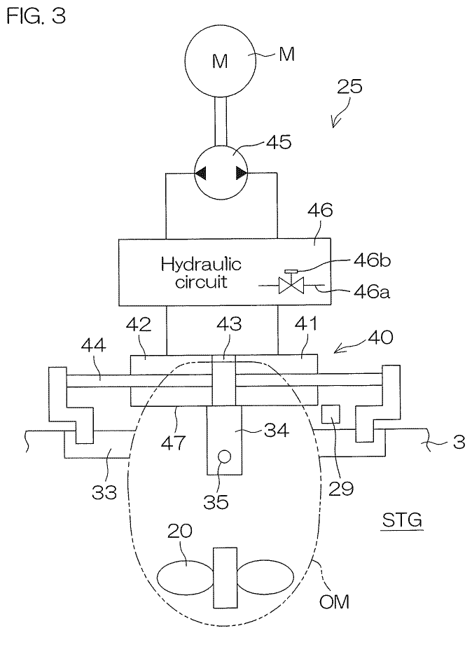

FIG. 3 is a diagram showing the structure of the steering STG by way of example. In this example, the steering STG is a hydraulic steering device. The steering STG includes a hydraulic pump 45, an electric motor M that drives the hydraulic pump 45, a hydraulic cylinder 40, and a hydraulic circuit 46 that causes a hydraulic oil to flow between the hydraulic pump 45 and the hydraulic cylinder 40. The hydraulic cylinder 40 is a dual action cylinder, and includes a cylinder tube 47, a piston 43 provided in the cylinder tube 47, and a piston rod 44 fixed to the piston 43 and extending to opposite sides of the piston 43.

The cylinder tube 47 and the piston rod 44 each extend laterally. The opposite end portions of the piston rod 44 are connected to the swivel bracket 33 of the outboard motor OM. The inside space of the cylinder tube 47 is partitioned into a right cylinder chamber 41 and a left cylinder chamber 42 by the piston 43. The cylinder tube 47 is linked to the steering arm 34 of the outboard motor OM. The cylinder tube 47 is guided by the piston rod 44 to be movable leftward and rightward. Thus, the steering arm 34 of the outboard motor OM is moved leftward and rightward to thus pivot (steer) the outboard motor OM about its steering shaft 35 leftward and rightward.

The hydraulic circuit 46 is connected to the right cylinder chamber 41 and the left cylinder chamber 42. The electric motor M is rotatable in normal and reverse rotation directions, and the hydraulic pump 45 pumps the hydraulic oil into one of the two cylinder chambers 41, 42 according to the rotation direction of the electric motor M. Thus, the cylinder tube 47 is moved leftward or rightward so that the one cylinder chamber has a greater volume and the other cylinder chamber has a smaller volume.

The electric motor M and the hydraulic pump 45 define the electric pump. Further, the steering actuator 25 includes a hydraulic actuator defined by the electric motor M, the hydraulic pump 45, the hydraulic circuit 46, and the hydraulic cylinder 40. The steering angle sensor 29 may be operable to detect the lateral position of the cylinder tube 47. Alternatively, the steering angle sensor 29 may be operable to detect the rotational position of the steering arm 34. Thus, the steering angle sensor 29 detects the steering angle of the outboard motor OM.

A bypass oil channel 46a through which the left and right cylinder chambers 41, 42 communicate with each other, and a relief valve 46b that opens and closes the bypass oil channel 46a are preferably provided in the hydraulic circuit 46. By manually opening the relief valve 46b, the left and right cylinder chambers 41, 42 communicate with each other through the bypass oil channel 46a. Therefore, the user can manually steer the outboard motor OM leftward and rightward by applying an external force to the outboard motor OM. By manually closing the relief valve 46b, the user can maintain the outboard motor OM at a desired steering angle. Thus, a manual operation mechanism for an emergency can be provided by the relief valve 46b and the like.

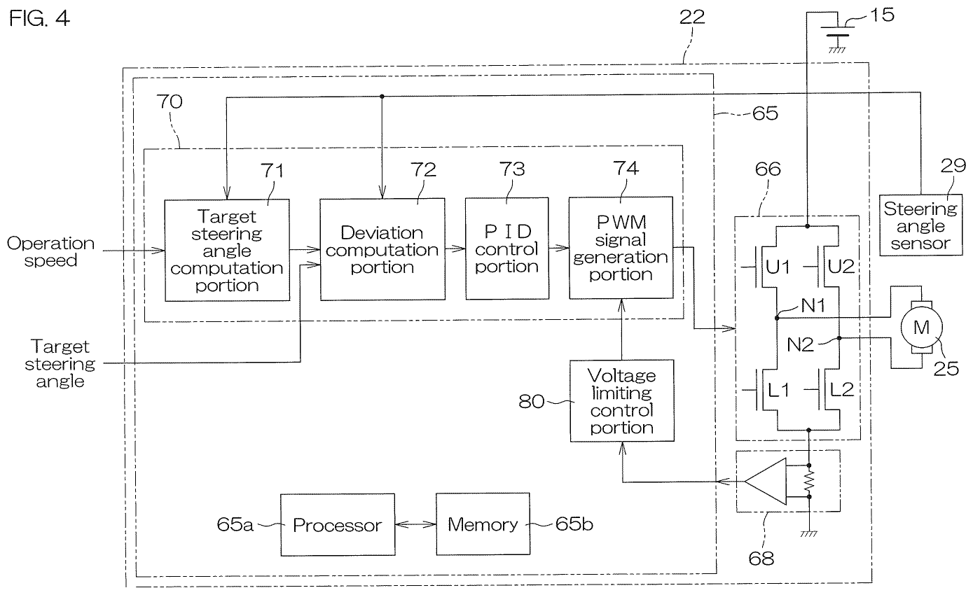

FIG. 4 is a block diagram showing the configuration of the steering controller 22 by way of example. The steering controller 22 includes a processing unit 65 and a drive circuit 66. The processing unit 65 includes a processor 65a and a memory 65b. The processing unit 65 is configured or programmed so that the processor 65a executes a program stored in the memory 65b to perform a plurality of functions. Specifically, the processing unit 65 is configured or programmed to function as a feedback control portion 70, a voltage limiting control portion 80 and the like.

The feedback control portion 70 feedback-controls the steering actuator 25 (more specifically, the electric motor M) based on the output signal of the steering angle sensor 29 (operation speed signal) so as to achieve the target steering angle.

The feedback control portion 70 functions as a target steering angle computation portion 71, a deviation computation portion 72, a PID (Proportional Integral Differential) control portion 73, and a PWM (Pulse Width Modulation) signal generation portion 74. The target steering angle computation portion 71 computes the target steering angle based on the operation speed signal applied from the helm controller 16. Specifically, the target steering angle computation portion 71 computes the target steering angle by summing operation speed signals. An initial value for the summation is the steering angle detected by the steering angle sensor 29. The deviation computation portion 72 computes the deviation of the steering angle (actual steering angle) detected by the steering angle sensor 29 from the target steering angle. The target steering angle to be used may be the target steering angle computed by the target steering angle computation portion 71, or may be the target steering angle included in the steering angle command applied from the remote control ECU 51. The PID control portion 73 performs a proportional integral differential operation on the deviation computed by the deviation computation portion 72 to generate a control value to reduce the deviation. The PWM signal generation portion 74 generates a PWM signal having a duty ratio according to the control value. The drive circuit 66 is driven based on the PWM signal generated by the PWM signal generation portion 74.

The drive circuit 66 includes an H-type bridge circuit connected to the battery 15 (also see FIG. 2) which is charged by the power generator 30 provided in the outboard motor OM. The H-type bridge circuit of the drive circuit 66 includes two series circuits each including an upper arm switching device U1, U2 and a lower arm switching device L1, L2, and the two series circuits are connected in parallel to the battery 15. The switching devices U1, U2, L1, L2 each typically include a semiconductor switch such as a power transistor. Two terminals of the electric motor M are respectively connected to a node N1 located between a pair of switching devices U1 and L1 of a first series circuit and a node N2 located between a pair of switching devices U2 and L2 of a second series circuit. The electric motor M is, for example, a DC motor (direct current motor). The switching devices U1, U2, L1, L2 are switched by the PWM signal generated by the PWM signal generation portion 74 such that a voltage is applied to the electric motor M according to the duty ratio of the PWM signal.

When the electric motor M is driven in the forward rotation direction, for example, the lower arm switching device L1 of the first series circuit and the upper arm switching device U2 of the second series circuit are maintained in an OFF state. Then, the upper arm switching device U1 of the first series circuit and the lower arm switching device L2 of the second series circuit are turned on and off by the PWM signal. When the electric motor M is driven in the reverse rotation direction, the upper arm switching device U1 of the first series circuit and the lower arm switching device L2 of the second series circuit are maintained in an OFF state. Then, the lower arm switching device L1 of the first series circuit and the upper arm switching device U2 of the second series circuit are turned on and off by the PWM signal.

Thus, the drive circuit 66 is driven by the PWM signal having the duty ratio according to the deviation (steering angle deviation) of the actual steering angle from the target steering angle such that the voltage is applied to the electric motor M to reduce the steering angle deviation. Thus, the steering angle of the outboard motor OM can be adjusted to the target steering angle. That is, the steering actuator 25 is feedback-controlled so that the actual steering angle detected by the steering angle sensor 29 approaches the target steering angle.

An electric current sensor 68 (electric current detection circuit) detects electric current (motor current) supplied from the drive circuit 66 to the electric motor M. The output signal of the electric current sensor 68 is inputted to the processing unit 65. The processing unit 65 can detect the motor current based on the output signal of the electric current sensor 68.

The voltage limiting control portion 80 performs a voltage limiting control operation to limit the voltage to be applied to the electric motor M according to the motor current. More specifically, the voltage limiting control portion 80 performs the voltage limiting control operation when a supply voltage limiting condition is satisfied.

The steering controller 22 performs a voltage control operation to control the voltage to be applied to the electric motor M (DC motor), and performs the voltage limiting control operation to limit the voltage to be applied to the electric motor M according to the motor current flowing through the electric motor M (as the function of the voltage limiting control portion 80). The voltage control operation is performed to control the voltage to be applied to the electric motor M by driving the drive circuit 66 by the PWM signal with its duty ratio properly set. In this case, the motor current flowing through the electric motor M depends upon the load torque of the electric motor M. As the load torque increases, the flowing motor current is increased. That is, the motor current of the electric motor M (DC motor) varies depending on the load torque, making it impossible to directly control the motor current. An overcurrent of the electric motor M increases the temperature of the electric motor M, thus reducing the efficiency of the electric motor M. Further, an overcurrent of the electric motor M is preferably avoided for protection of the switching devices U1, L1, U2, L2 of the drive circuit 66.

In the present example embodiment, therefore, the voltage limiting control operation is performed to limit the voltage to be applied to the electric motor M when a predetermined voltage limiting condition (overcurrent condition) is satisfied. Thus, the motor current is reduced.

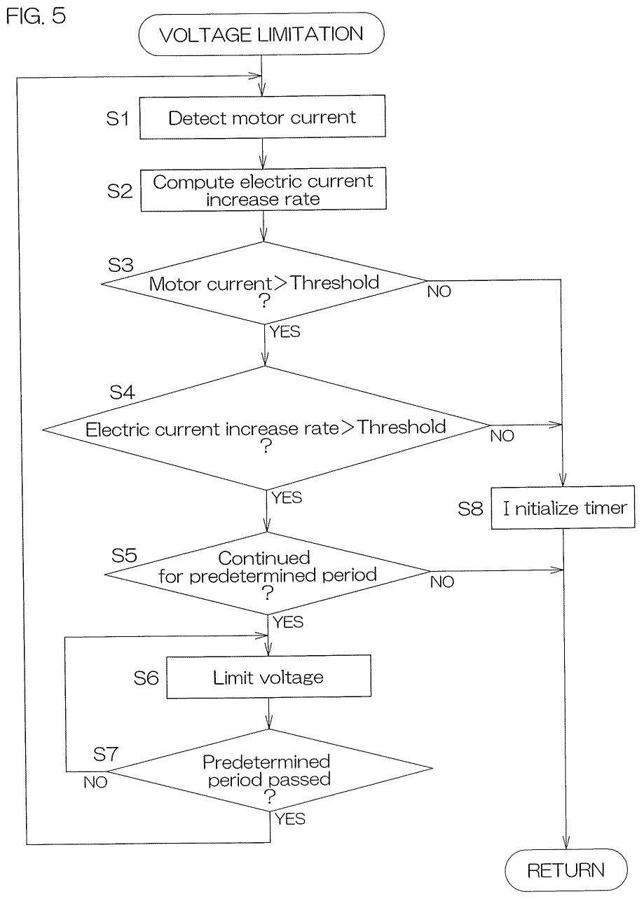

FIG. 5 is a flowchart for describing an example of the voltage limiting control operation (as the function of the voltage limiting control portion 80) to be performed by the steering controller 22, showing an exemplary process to be performed repeatedly in a predetermined control cycle by the steering controller 22. The steering controller 22 detects the motor current based on the output signal of the electric current sensor 68 (Step S1). Further, the steering controller 22 determines the increase rate of the motor current (e.g., an increase of the motor current in the control cycle) based on the value of the motor current detected by reading the output signal of the electric current sensor 68 in the predetermined control cycle (Step S2).

The voltage limiting condition includes one or both of a motor current condition such that the motor current exceeds a predetermined electric current threshold (Step S3) and an electric current increase rate condition such that the increase rate of the motor current exceeds a predetermined increase rate threshold (Step S4). For example, the steering controller 22 may be programmed to limit the voltage (Step S6) when the voltage limiting condition is continuously satisfied for a predetermined period or longer (YES in Step S5). In FIG. 5, the voltage is limited (Step S6) when the motor current condition (Step S3) and the electric current increase rate condition (Step S4) are both continuously satisfied for the predetermined period or longer (YES in Step S5), by way of example.

Specifically, the duty ratio of the PWM signal may be limited for the voltage limitation. For example, a duty ratio of 0% to 100% may be permitted when the voltage is not limited, and the upper limit of the duty ratio may be limited to lower than 100% (e.g., about 80%) when the voltage limitation is started. The voltage limitation may be achieved by a process such that the duty ratio determined by the PID operation is multiplied by a predetermined factor of less than 1 (e.g., about 0.8) for the limitation of the duty ratio.

The steering controller 22 may be configured or programmed to continue the voltage limitation for a predetermined voltage limitation period (Step S7), and then return to Step S1 to determine again whether or not the voltage limiting condition (Steps S3 and S4) is satisfied. That is, when the voltage limiting condition is satisfied (YES in Steps S3, S4, S5) even after the voltage is limited for the predetermined voltage limitation period (YES in Step S7), the steering controller 22 still continues the voltage limitation (Step S6). When the voltage limiting condition is not satisfied (NO in Step S3 or S4), on the other hand, the steering controller 22 stops a time measuring operation by initializing a timer that measures a continuation period during which the voltage limiting condition is satisfied, thus ending the process. Therefore, the voltage limitation ends. Thereafter, a process sequence from Step S1 is repeated.

When the continuation period during which the voltage limiting condition is satisfied (YES in Steps S3 and S4) is shorter than the predetermined period (NO in Step S5), the process ends while the continuation period is continuously measured (i.e., without the initialization of the timer). Thereafter, the process sequence from Step S1 is repeated.

In an example embodiment, as described above, the electric motor M as the power source of the steering actuator 25 includes the DC motor (direct current motor). The DC motor is typically a brushed DC motor. The brushed DC motor includes, for example, stator magnets, a rotor coil, a commutator connected to opposite ends of the coil, and brushes in contact with the commutator. The use of the DC motor is advantageous in that the cost of the steering actuator 25 can be reduced. On the other hand, the motor current of the DC motor varies depending on the load torque, making it impossible to directly control the motor current. In the present example embodiment, therefore, the voltage control operation is performed to feedback-control the DC motor so that the steering angle (actual steering angle) detected by the steering angle sensor 29 approaches the target steering angle and, at the same time, the voltage to be applied to the DC motor is limited according to the motor current. This makes it possible to properly feedback-control the steering STG with the use of a less expensive DC motor while avoiding an overcurrent state. Thus, the watercraft maneuvering system 100 is suitable to steer the watercraft 1.

In an example embodiment, when the voltage limiting condition including at least one of the motor current condition in which the motor current exceeds the predetermined electric current threshold or the electric current increase rate condition in which the increase rate of the motor current exceeds the predetermined increase rate threshold is satisfied, the steering controller 22 performs the voltage limiting control operation. This makes it possible to properly feedback-control the steering STG with the use of the DC motor while avoiding an overcurrent state.

In an example embodiment, when the voltage limiting condition is continuously satisfied for the predetermined period, the steering controller 22 performs the voltage limiting control operation. Thus, an unnecessary voltage limitation can be avoided. This makes it possible to stably perform the control operation while avoiding an overcurrent state.

While example embodiments of the present invention have thus been described, the present invention may be embodied in some other ways as will be described below by way of example.

In the example embodiments described above, the watercraft 1 is configured such that the single outboard motor OM is attached to the hull 2 by way of example, but the example embodiments described above may be applied to a watercraft configured such that two or more outboard motors are attached to the hull 2.

A propulsion device other than the outboard motor may be used. Specifically, the example embodiments described above may be applied to a watercraft including an inboard motor, an inboard/outboard motor, a waterjet propulsion device or other type of propulsion device.

The prime mover for the propulsion device is not necessarily required to be the engine, but may be an electric motor.

The steering angle is not necessarily required to be the steering angle of the outboard motor, but may be the angle of a rudder plate.

The joystick may be used instead of the steering wheel as the steering operator.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft maneuvering system comprising:
a steering including a steering actuator including a DC motor and operable to change a steering angle to change a course of a watercraft;
a steering angle sensor to detect the steering angle; and
a steering controller configured or programmed to drive the steering actuator by feedback-controlling the DC motor based on a target steering angle and an output signal of the steering angle sensor; wherein
the steering controller is configured or programmed to perform a voltage control operation to control a voltage to be applied to the DC motor, and to perform a voltage limiting control operation to limit the voltage to be applied to the DC motor based on a motor current flowing through the DC motor.

2. The watercraft maneuvering system according to claim 1, wherein the steering controller is configured or programmed to perform the voltage limiting control operation when a voltage limiting condition including at least one of a motor current condition in which the motor current exceeds a predetermined electric current threshold, or an electric current increase rate condition in which an increase rate of the motor current exceeds a predetermined increase rate threshold is satisfied.

3. The watercraft maneuvering system according to claim 2, wherein the steering controller is configured or programmed to perform the voltage limiting control operation when the voltage limiting condition is continuously satisfied for a predetermined period or longer.

4. The watercraft maneuvering system according to claim 1, wherein the steering controller is configured or programmed to perform the voltage control operation by controlling a motor driving circuit connected to the DC motor through a Pulse Width Modulation (PWM) control, and to limit a duty ratio of the PWM control in the voltage limiting control operation.

5. The watercraft maneuvering system according to claim 1, further comprising:
a steering operator to be operated by a user to perform a steering operation; and
an operation sensor to detect the steering operation of the steering operator; wherein
the steering controller is configured or programmed to compute the target steering angle based on an output signal of the operation sensor.

6. The watercraft maneuvering system according to claim 5, further comprising a main controller configured or programmed to generate the target steering angle and to apply the target steering angle to the steering controller in a watercraft maneuvering mode independent of the steering operation of the steering operator.

7. The watercraft maneuvering system according to claim 1, wherein the steering actuator includes a hydraulic actuator including a hydraulic cylinder and a pump to supply a hydraulic oil to the hydraulic cylinder, and the DC motor is operable to drive the pump.

8. The watercraft maneuvering system according to claim 1, wherein the steering is operable to steer an outboard motor attached to a hull of the watercraft.

9. A watercraft maneuvering system comprising:
a steering including a steering actuator including a DC motor and operable to change a steering angle to change a course of a watercraft; and
a steering controller configured or programmed to perform a voltage control operation to drive the DC motor, and to perform a voltage limiting control operation to limit a voltage to be applied to the DC motor when a predetermined overcurrent condition is satisfied.

10. A watercraft comprising:
a hull; and
the watercraft maneuvering system according to claim 1 provided on the hull.

11. A watercraft comprising:
a hull; and
the watercraft maneuvering system according to claim 9 provided on the hull.
